(19) United States
(12) Patent Application Publication
(10) Pub. No.: US 2012/0236098 A1
(43) Pub. Date: Sep. 20, 2012

(54) THERMAL INK TRANSFER USING ENDLESS BELT

(75) Inventors: Ashish Pattekar, San Mateo, CA (US); Eric Peeters, Mountain View, CA (US)

(73) Assignee: PALO ALTO RESEARCH CENTER INCORPORATED, Palo Alto, CA (US)

(21) Appl. No.: 13/481,645

(22) Filed: May 25, 2012

Related U.S. Application Data
(62) Division of application No. 12/856,489, filed on Aug. 13, 2010.

(51) Int. Cl. B41J 2/01

(52) U.S. Cl. 347/102

(57) ABSTRACT

An embodiment is a method and apparatus for thermal ink transfer. An endless belt having a thin thickness transfers ink from an ink donor roll to an image substrate based on a pattern on the belt. A heating unit heats the belt locally as needed in vicinity of contact between the belt and the ink donor roll.

One disclosed feature of the embodiments is a method to transfer ink. An endless belt is driven to transfer ink from an ink donor roll to an image substrate based on a pattern of a fountain solution formed on the belt. The belt is heated locally as needed in vicinity of contact between the belt and the ink donor roll.

### CROSS-REFERENCE To RELATED APPLICATIONS

This application is a Divisional of application Ser. No. 12/856,489, filed Aug. 13, 2010, now U.S. Patent No. ______, the entire contents of which are incorporated herein by reference.

### TECHNICAL FIELD

The presently disclosed embodiments are directed to the field of printing technology, and more specifically, to thermal ink transfer.

### BACKGROUND

Thermal ink transfer to and from various surfaces and materials has been discussed in printing technology. For example, U.S. Pat. No. 4,080,897 discloses a method for selective tack imaging and printing. One of the main imaging surfaces that has been used in this printing process has been in the form of a drum with a silicone (e.g., poly-organo siloxane) coating, where the ink ‘tack’ (a property arising out of the interaction between the cohesive forces within the ink bulk and the adhesive forces between the ink and the silicone imaging surface) is manipulated by controlling the local temperature. By selectively heating the ink/imaging surface at local image regions, the ink tack is manipulated such that the ink transfers to the silicone surface to form an image pattern. No heat is applied at the non-image areas, where the ink does not transfer to the silicone surface in this selective thermal-tack ink transfer approach.

Most of the existing techniques use a drum-based silicone imager or a silicone imaging surface coated on a transparent support (e.g. U.S. Pat. No. 4,080,897). These techniques suffer from a number of disadvantages. One of the limitations of the drum-based silicone imager is the need to make a precision silicone coating on a drum or transparent support, which can be expensive. Moreover, the drum or the transparent support itself adds thermal mass (e.g., heat capacity) to the system. Since on-the-fly digital printing would necessitate high speed heating and cooling to rewrite thermal images with every pass of the imaging cylinder, any increase in the thermal mass of the imaging member directly translates into higher energy loads and inefficient operation. Another disadvantage of using a high thermal mass imaging member is that the heat stored in the imaging member will be conducted to every roll that is rotating in contact with the imaging cylinder, and from there on further downstream/upstream to every roll in contact with these in the rest of the print system. Thus at a steady operating state, the entire print system could reach the high operating temperature of the imaging surface unless there is active cooling—resulting in further thermally inefficient operation. If the temperature of the overall system stays at a high value (>50° C.) at steady state operation, the ink fountain may start drying out—leading to roller jams, ink wastage, and costly down-times related to cleanup of the dried and caked-on ink.

There have also been previous attempts at electronic lithography in offset printing through the in-situ patterning of ‘offset fountain solution’ that is deposited on to an offset plate prior to inking (U.S. Pat. Nos. 3,741,118 and 3,800,699). This electronic lithography approach utilizes the formation of an ink image on the offset plate through the application of an inverse pattern of the fountain solution prior to inking, with the ink image being formed in locations on the offset plate at regions devoid of fountain solution—similar to conventional offset lithography. In contrast to conventional offset lithography, however, the electronic lithography approach allows the realization of a ‘variable data’ print system wherein the image pattern can be changed for each individual page or image transfer through on-the-fly manipulation of the fountain solution image during printing. However, a major limitation of this approach of electronic lithography in the prior art is the difficulty associated with the clean-up of the ink at every pass of the offset plate. Without 100% transfer of the ink to the image substrate, true variable-data electronic lithography (wherein the image pattern changes from one page to the next), would require extensive clean-up of the residual ink image from the offset plate at every pass to avoid image ghosting resulting from ink left on the plate from the previous image. Moreover, the ink clean-up step would lead to wastage of the ink at every print pass, making the process significantly expensive,

### SUMMARY

One disclosed feature of the embodiments is a technique for thermal ink transfer. An endless belt having a thin thickness transfers ink from an ink donor roll to an image substrate based on a pattern on the belt. A heating unit heats the belt locally as needed in vicinity of contact between the belt and the ink donor roll.

One disclosed feature of the embodiments is a method to transfer ink. An endless belt is driven to transfer ink from an ink donor roll to an image substrate based on a pattern of a fountain solution on the belt. The belt is heated locally as needed in vicinity of contact between the belt and the ink donor roll.

### BRIEF DESCRIPTION OF THE DRAWINGS

Embodiments may best be understood by referring to the following description and accompanying drawings that are used to illustrate various embodiments. In the drawings.

FIG. 1 is a diagram illustrating a system according to one embodiment.

FIG. 2 is a diagram illustrating an ink transfer unit according to one embodiment.

FIG. 3 is a flowchart illustrating a process to thermally transfer ink according to one embodiment.

FIG. 4 is a flowchart illustrating a process to heat the belt using a heat source according to one embodiment.

FIG. 5 is a flowchart illustrating a process to heat the belt using an electrical circuit according to one embodiment.

### DETAILED DESCRIPTION

One disclosed feature of the embodiments is a technique for thermal ink transfer. An endless belt having a thin thickness transfers ink from an ink donor roll to an image substrate based on a pattern on the belt. In one embodiment, the pattern may be a thermal image formed on the endless belt by a means of selective deposition of energy at locations on the belt corresponding to the image areas. A heating unit heats the endless belt locally as needed in vicinity of contact between the endless belt and the ink donor roll. In one embodiment, the belt may be made of silicone, such as a poly-organo siloxane material.

One disclosed feature of the embodiments is a method to transfer ink. An endless belt is driven to transfer ink from an ink donor roll to an image substrate based on a pattern on the belt formed prior to contact with the ink donor roll. In one embodiment, the pattern may be a fountain solution pattern. The belt is heated locally as needed in vicinity of contact between the belt and the ink donor roll. In one embodiment, the belt may be made of silicone, such as a poly-organo siloxane material.

One disclosed feature of the embodiments may be described as a process which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a program, a procedure, a method of manufacturing or fabrication, etc. One embodiment may be described by a schematic drawing depicting a physical structure. It is understood that the schematic drawing illustrates the basic concept and may not be scaled or depict the structure in exact proportions.

One disclosed feature of the embodiments is a method and apparatus for thermal ink transfer printing. The printing uses a low thermal mass imaging member in the form of a thin endless belt. Compared to prior art techniques using silicone-coated drum or a silicone coated transparent substrate (e.g., as in U.S. Pat. No. 4,080,897), the maximum thermal penetration in the belt may only be up to its thickness, resulting in high efficiency. The imaging belt may also be heated and cooled from both sides if needed, which translates into faster and more efficient heating and cooling at the desired local regions. Since the imaging belt may be quickly heated just before ink transfer to it and may also be quickly cooled immediately after, this translates into minimal heat energy leakage into the rest of the system. The belt temperature at regions away from the ink transfer zones are typically maintained at close to room temperature, thus avoiding heat leakage to the inking subsystem and the potential ink dryout.

A sacrificial material, such as an offset fountain solution, may be used to provide ink transfer selectivity. The fountain solution may be used to create a pattern on the imaging belt. The fountain solution may include water and some additives that may reduce its surface tension. The silicone imaging surface may be used mainly for its ability to accept ink from an ink donor roll at elevated (‘ink accepting’) temperatures (e.g., greater than 50° C.) and to transfer substantially all of the ink to a substrate such as paper at a temperature lower than the ink accepting temperature (e.g., at room temperature), which obviates potential ghosting and on-the-fly clean-up issues. This “hybrid” approach provides advantages of using a fountain solution pattern for ink selectivity and addressing similar to a traditional offset press and the method of electronic lithography described in U.S. Pat. Nos. 3,741,118 and 3,800,699, while at the same time allowing for 100% ink transfer to the substrate, thus simplifying much of the ghosting and clean-up issues associated with true variable-data digital offset printing, which are not described in the prior art.

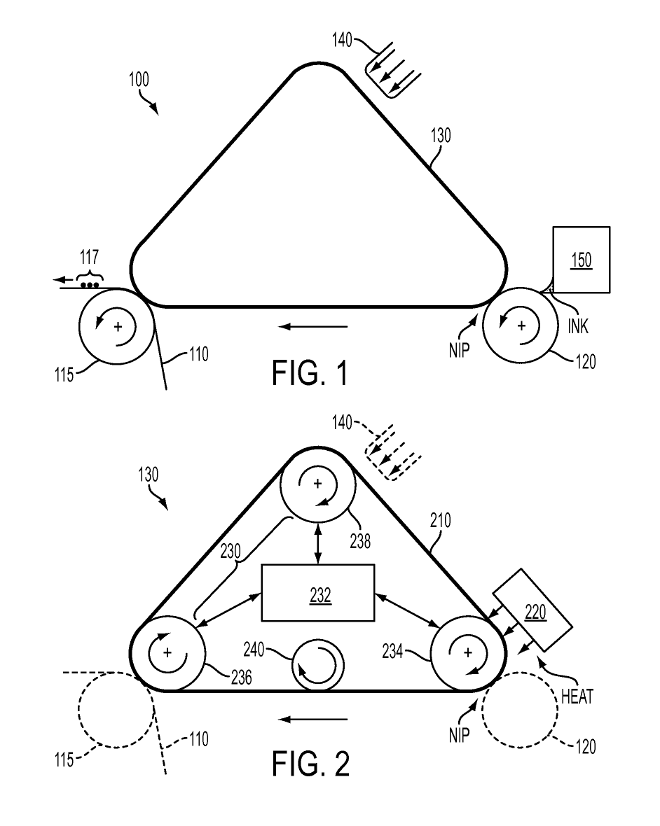

FIG. 1 is a diagram illustrating a system 100 according to one embodiment. The system 100 includes an image substrate 110 (e.g., paper), an ink donor roll 120, an ink transfer unit 130, a fountain solution subsystem 140, and an ink fountain unit 150. The system 100 may include more or less components than the above.

The image substrate 110 may be any substrate such as a web, or individual sheets of paper or plastic or other suitable material to be printed on, that is used to form a printed image 117. The image substrate 110 may come in at room temperature.

The ink donor roll 120 may include a roller to provide ink to the ink transfer unit 130. In one embodiment, the ink donor roll 120 supplies the ink when the ink transfer unit 130 is dry.

The ink transfer unit 130 transfers the ink fed from the ink donor roll 120 to the image substrate 110. In one embodiment, the ink transfer unit 130 includes a low thermal mass imaging member to provide high efficient heating and cooling which reduces heat energy leakage into the rest of the system. The ink transfer unit 130 has a contact area with the ink donor roll which may include a nip at the contact. The ink transfer unit 130 is described in further details in FIG. 2.

As the ink transfer unit 130 transfers the ink from the ink donor roll 120 to the image substrate 110, the ink transfer unit 130 may be cooled by a cooling mechanism. The cooling mechanism may provide cool air or cool fluid to cool the ink transfer unit 130. Since the imaging member (as described in FIG. 2) of the ink transfer unit 130 has a low thermal mass, this cooling may be achieved fast and efficiently. A cooling roll may be used to provide the necessary cooling.

The fountain solution subsystem 140 provides a pattern of the fountain solution onto the imaging member in the ink transfer unit 130 before its contact with the ink donor roll 120. The fountain solution may include a suitable surfactant to enable spreading on the surface of the imaging member. It may include a mixture of water and some additives including surfactants to reduce the surface tension. The subsystem 140 may provide a pattern of the fountain solution onto the imaging member. The solution patterning may be performed by one of two methods. In the first method, the fountain solution may be deposited onto the belt by jetting as droplets (e.g., as in inkjet print-head systems). The diameter of the droplets may range from 5 μm to 40 μm. The final thickness of the coating may range from 0.1 μm to 2 μm. These values are for illustrative purposes. This method is referred to as the additive approach. In the second method, the belt may be first blanket coated with the fountain solution, then the fountain solution is selectively removed from areas corresponding to the final ink image (‘image areas’) through vaporization or ablation (e.g., through application of energy such as heating using a laser or other electromagnetic radiation, or through the impingement of directed jets of heated air or other gas). This method is referred to as the subtractive approach.

The ink fountain unit 150 may include an actively cooled ink fountain and an ink fountain roller to provide the ink to the ink donor roll 120. The ink fountain unit 150 may be actively cooled to eliminate any potential dry-out of ink at the fountain. One advantage of this design is that the low thermal mass of the ink transfer unit 130, and especially the imaging member, carries minimal heat to the ink fountain and the rest of the system, thus reducing energy losses and potential cooling requirements.

FIG. 2 is a diagram illustrating the ink transfer unit 130 shown in FIG. 1 according to one embodiment. The ink transfer unit 130 includes an endless belt 210, a heating unit 220, a driving mechanism 230, and a cooling roll 240. The ink transfer unit 130 may include more or less than the above components.

The endless belt 210 may act as the imaging member discussed above. In one embodiment, it may be made of silicone, such as a poly-organo siloxane material. It may have a thin thickness and transfer ink from the ink donor roll 120 to the image substrate 110. In one embodiment, the thin thickness may be approximately less than 1 mm. In another embodiment, the thin thickness of the belt may be between 10 pm to 500 pm. Due to the thin thickness, the belt 210 has a very low thermal mass which means that the belt 210 may be heated and/or cooled very quickly and efficiently.

The heating unit 220 heats the belt 210 locally as needed in vicinity of the contact between the belt 210 and the ink donor roll 120. The heating unit 220 may heat the belt 210 at a temperature between 50° C. to 90° C. In one embodiment, the heating unit 220 may include a heating source positioned in the vicinity of, or just prior to, the contact between the belt 210 and the ink donor roll 120, to supply heat to the belt 210. The heating source may be one of a radiant source, a laser, an infrared lamp, a hot air or other suitable hot gas source, an induction heater, or any other suitable heating mechanism. In another embodiment, the heating unit 220 may include an electrical circuit to drive a current through the nip at the contact or across the silicone belt at the nip (not shown in figure). The advantage of local heating directly in the nip is that the heat input to the belt may be pulsed or driven as needed, thereby avoiding unnecessary waste of energy through conduction to the ink donor roll 120 and the resulting ink dry-out such as in the cases when the donor roll 120 itself is heated by the conduction at the belt contact point.

The driving mechanism 230 is coupled to the belt 210 to drive the belt 210. The driving mechanism 230 may include rollers 234, 236, and 238. The rollers 234, 236, and 238 may be interfaced with, driven by, or synchronized with a motorized unit 232. The motorized unit 232 may be part of the driving mechanism 230 or separated from it.

The motorized unit 232 provides the rotational force to drive the rollers 234, 236, and 238. The rollers 234, 236, and 238 may be inside the belt 210. The endless belt 210 may rest on the rollers 234, 236, and 238 to travel in a rotational direction as the rollers 234, 236, and 238 are activated. The speed of rotation may be adjusted and depend on the overall imaging requirements. More or less rollers than those shown in FIG. 2 may be used to drive and/or support the belt 210.

The roller 234 may support the silicone belt 210 at the contact with the ink donor roll 120. As discussed above, the contact may provide a nip at which the heating unit 220 may provide local heating, or heating to the nip may be carried out through another mechanism or a combination of other mechanisms as discussed above.

The cooling roll 240 may be employed to provide cooling of the belt 210 as it travels from the ink donor roll 120 to the image substrate 110. The cooling roll 240 may use cool air or cool fluid (for removing heat from the belt). As discussed above, due to the low thermal mass of the belt 210, the cooling may be achieved very quickly and efficiently before contact with the image substrate 110. The efficiency is due to the small amount of heat involved in the heat transfer. The cooling ensures 100% transfer of ink to the image substrate from the belt, a characteristic of the belt surface material (e.g., silicone). Other cooling mechanisms such as direct coolant (e.g., air) impingement onto the belt 210 and/or a combination of multiple cooling rolls (not shown) may also be used to achieve the desired cooling of the belt 210.

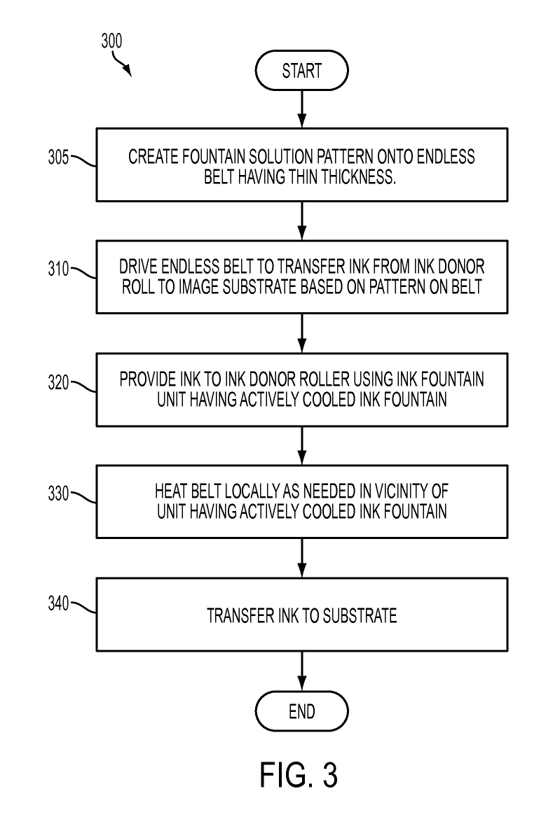

FIG. 3 is a flowchart illustrating a process 300 to thermally transfer ink according to one embodiment.

Upon START, the process 300 creates a fountain solution pattern onto an endless belt having a thin thickness (Block 305). The fountain solution pattern may be created using an additive or a subtractive approach. In the additive approach, the fountain solution may be jetted onto the belt as very fine droplets to form a desired pattern. In the subtractive approach, the belt may be blanket coated with the fountain solution and radiation (e.g., laser) patterned to selectively remove the fountain solution in the area on the belt not occupied by the fountain solution pattern by vaporization or ablation. The belt typically has a low thermal mass. In one embodiment, the belt may be made of silicone, such as a poly-organo siloxane material. In one embodiment, the thin thickness may be less than 1 mm. In another embodiment, the thin thickness may be between 10 μm to 500 μm. Then, the process 300 drives the endless belt to transfer ink from an ink donor roll to an image substrate based on the fountain solution pattern on the belt (Block 310). This may include supporting the silicone belt by a first roller inside the silicone belt at the contact with the ink donor roll. In one embodiment, the fountain solution pattern acts as a release layer, thereby allowing the ink only to transfer to the dry (e.g., non-fountain solution) regions of the imaging member/belt to form an ink image in the negative of the fountain solution pattern. The process 300 may optionally provide the ink to ink donor roller using an ink fountain unit having an actively cooled ink fountain (Block 320). The process 300 heats the silicone belt locally as needed in vicinity of contact between the belt and the ink donor roll (Block 330). The heating unit may heat the belt to a temperature between 50° C. to 90° C., which makes the belt surface ink accepting.

Then, the process 300 transfers the ink to the belt surface, and subsequently from the belt surface to the substrate (Block 340). The process 300 is then terminated.

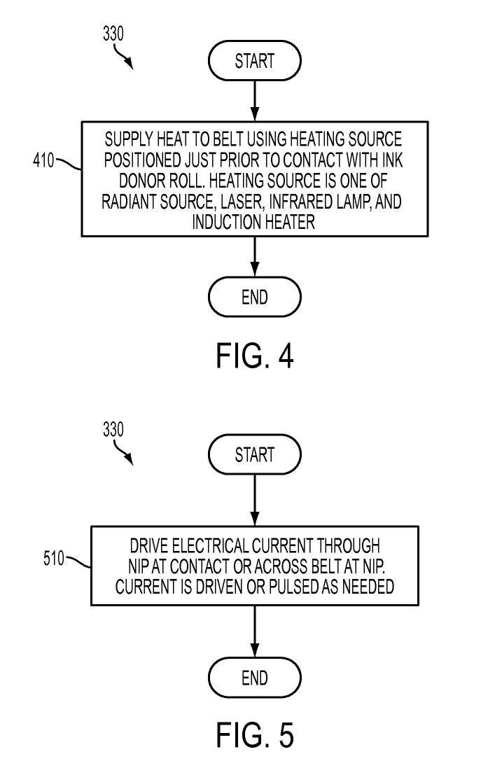

FIG. 4 is a flowchart illustrating the process 330 to heat the belt using a heat source according to one embodiment.

Upon START, the process 330 supplies heat to the belt using a heating source positioned just prior to the contact with the ink donor roll (Block 410). The heating source may be one of a radiant source, a laser, an infrared lamp, and an induction heater, or any combination of the above. The process 330 is then terminated.

FIG. 5 is a flowchart illustrating the process 330 to heat the belt using an electrical circuit according to one embodiment.

Upon START, the process 330 drives an electrical current through nip at the contact or across the belt at the nip (Block 510). The current may be driven or pulsed as needed for efficient energy consumption and dissipation. The process 330 is then terminated.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method comprising:
creating a pattern of a fountain solution on an endless belt having a thin thickness;
driving the endless belt to transfer ink from an ink donor roll to an image substrate based on the pattern; and
heating the belt locally as needed in vicinity of contact between the belt and the ink donor roll.

2. The method of claim 1 wherein driving the endless belt comprises:
supporting the belt by a first roller inside the belt at the contact with the ink donor roll.

3. The method of claim 1 wherein heating comprises:
supplying heat to the belt using a heating source positioned in vicinity of the contact.

4. The method of claim 3 wherein the heating source is one of a radiant source, a laser, an infrared lamp, and an induction heater.

5. The method of claim 1 wherein heating comprises:
driving a current through nip at the contact or across the belt at the nip.

6. The method of claim 1 further comprising:
providing the ink to ink donor roller using an ink fountain unit having an actively cooled ink fountain.

7. The method of claim 1 wherein the thin thickness is less than 1 mm.

8. The method of claim 1 wherein the thin thickness is between 10 μm to 500 μm.

9. The method of claim 1 wherein creating the pattern comprises:
depositing the fountain solution on the belt by jetting.

10. The method of claim 1 wherein creating the pattern comprises:
blanket coating the belt by the fountain solution; and
selectively removing the fountain solution from area on the belt not occupied by the fountain solution.

11. The method of claim 1 wherein the belt is made of silicone including a poly-organo siloxane material.
